(19) United States
(12) Patent Application Publication
(10) Pub. No.: US 2003/0160939 A1
(43) Pub. Date: Aug. 28, 2003

(54) A TEMPLE LESS EYEGLASS FRAME ASSEMBLY HAVING OPEN OPPOSITE ENDS CONNECTED TOGETHER BY A CONTINUOUS SOFT STRIP OF TERRY CLOTH FOR POST OPERATIVE USE

(76) Inventor: Meridyth Webber, Teaneck, NJ (US)

Correspondence Address: Eugene Lieberstein, 2151 Long Ridge Road, Stamford, CT, 06903, US

(21) Appl. No.: 10/084,701

(22) Filed: Feb. 28, 2002

(51) Int. Cl. G02C 1/00; G02C 5/16

(52) U.S. Cl. 351/114

(57) ABSTRACT

An eyeglass assembly for use following surgery comprising a temple less frame for housing a pair of lenses, a bracket connector extending from each opposite end of the frame on the left and right side thereof and a soft strip of a terry cloth connecting material removably connected to each bracket connector. The terry cloth strip of connecting material has a fastener at each opposite end thereof for attachment to the bracket connectors preferably using a snap fitting for one of the fasteners and a Velcro liner for the other.

### FIELD OF INVENTION

This invention relates to an eyeglass assembly having a frame without temple supports for use following facial and/or eye surgery.

### BACKGROUND OF THE INVENTION

Recovery from facial and/or eye surgery requires a substantial period of convalescence to enable the face and eyes to properly heal. To avoid injury and discomfort to the area of the face and eyes the patient is told not to wear normal eye glasses during the period of convalescence. However, care for personal hygiene is also an important part of the healing process and it is essential for the emotional normal well being of a patient to be able to function in a normal fashion which cannot be done if the patient cannot use prescription glasses if necessary to see and read The glasses of the present invention are designed to accommodate the patient during this period of convalescence following surgery by relieving the pressure normally applied by the temple support portions of the frame against the sides of the head of the wearer.

Many different type of eyeglass holding or retaining accessories are available based upon the concept of connecting the ends of the temple support portions of the frame to one another behind the wearer's head and around the ears. This is usually done with a strap affixed to the open ends of the temple support portions of the frame extending around the ears. It is also known to clamp the frames to the head using a strap or belt of leather or like material including plastic with the objective of holding the frames of the glasses secure against the head so that the wearer can participate in active sports particularly where the alignment of the glasses must be accurately maintained on the bridge of the nose relative to the position of the eyes. To accomplish this the strap or belt must apply at least as much or more pressure against the sides of the head as is normally applied by the temple support portions of conventional frame glasses.

None of the eyeglass holding devices of the prior art permit use of eyeglasses immediately following post operative surgery on the face and/or eyes. The frames of the present invention are designed for use without temple support portions. Instead a soft absorbent material composed of cloth is used to loosely interconnect the frame on the opposite sides of the head without the use of temple supports in a way that permits little or no pressure to be applied to the sides of the head or forehead of the wearer and without inflicting any pain during the normal healing process.

### SUMMARY OF THE INVENTION

An eyeglass assembly has been discovered pursuant to the present invention that includes a frame without temple supports for use following post operative surgery which does not inflict pain and does not interfere with the normal healing process. The eyeglass assembly includes eyeglass frames having opposite open ends connected by means of an absorbent cloth preferably composed of looped absorbent stretchable fabric such as terry cloth. In the preferred embodiment at least one end of the cloth has a Velcro lining so that the length of the cloth connecting the open ends of the frame is readily adjustable. Moreover, each open end of the frame may include a connector having an opening through which the cloth can be readily threaded.

The eyeglass assembly of the present invention comprises a frame for housing a pair of lenses, a connector extending from two opposite open ends of the frame and a connecting strip of a cloth material composed of a soft looped absorbent stretchable fabric with the connecting strip having means at each opposite end thereof for removably attaching the connecting strip to the connector. In the preferred embodiment each connector is in the configuration of a loop which may be molded integrally with the frame as an extension thereof. The connecting strip may include at one or both ends a Velcro liner for adjusting the length of the connecting strip and/or a snap fitting at the other end or at both ends.

### BRIEF DESCRIPTION OF THE DRAWINGS

Other advantages of the present invention will become apparent from the following detailed description of the invention when read in conjunction with the accompanying drawings of which:

FIG. 1 is a view in perspective of the eyeglass assembly of the present invention with the opposite open ends of the frame interconnected by means of an adjustable strip of absorbent terry cloth;

FIG. 2 is an enlarged view of the open bracket extending from the right side of the eyeglass frame in FIG. 1 showing the strip of terry cloth connected to the eyeglass frame on the right side thereof by means of a snap fitting;

FIG. 2B is an enlarged view of the open bracket extending from the left side of the eyeglass frame in FIG. 1 showing the strip of terry cloth connected to the eyeglass frame on the left side thereof by a Velcro fastener which is adjustable and

FIG. 3 is a schematic view of the strip of terry cloth of FIG. 1 in a different orientation from that shown in FIG. 1 to better illustrate the snap fitting on the right side thereof and the Velcro fitting on the left side.

### DETAILED DESCRIPTION OF THE PREFERRED EMBODIMENT

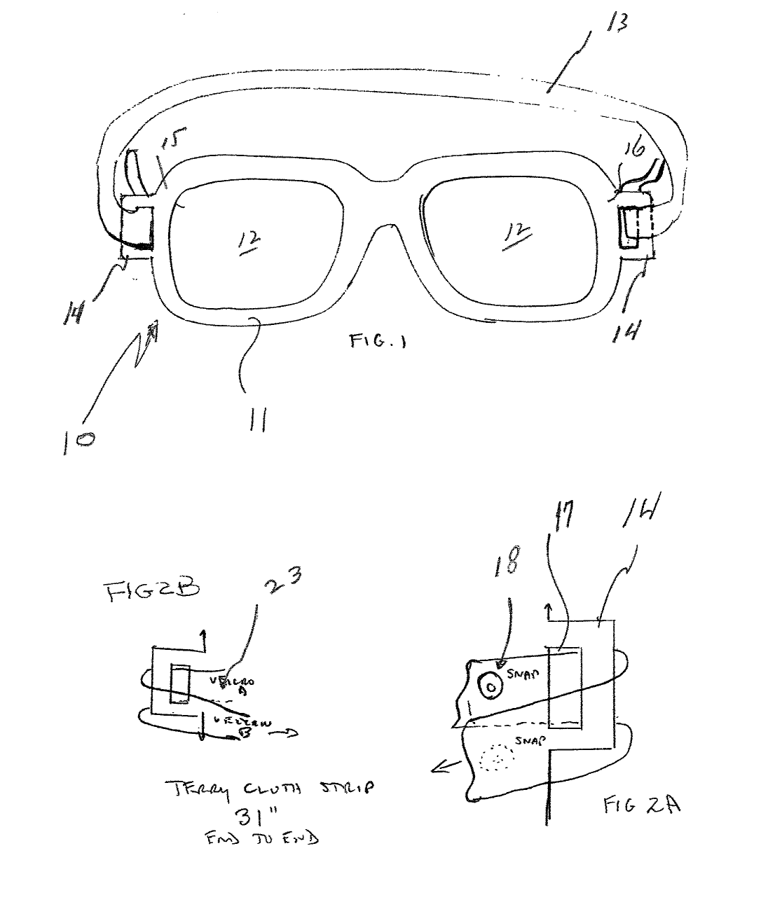

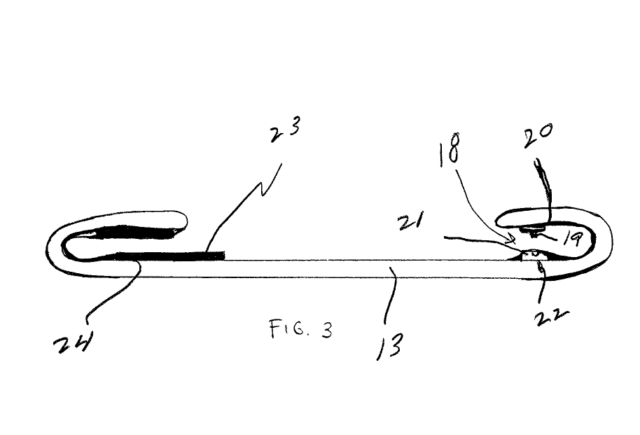

The eyeglass assembly 10 of the present invention as shown in FIG. 1 comprises a conventional frame 11 of any desired shape having a pair of eyeglass lenses 12 removably inserted therein. Although the frame 11 is conventional it does not have any temple supports. Instead a pair of bracket connectors 14 extend symmetrically from each opposite end 15 and 16 of the frame 11. The bracket connectors 14 can be of any geometry preferably with an opening 17 at or near the center thereof forming a loop through which a strip 13 of connecting material is removably inserted.

The bracket connectors 14 may be composed of plastic or any other material and is preferably of a material similar in composition to the composition selected for the frame 11 so that the frame 11 and bracket connectors 14 may be fabricated or molded as one integral unit. Having an opening 17 in each bracket connector 14 is preferred However, as an alternative, the connectors 14 can be a solid structure in the form of a post or shaped to form a winch to which the strip 13 of connecting material can be removably attached.

The strip 13 of connecting material is composed of any soft stretchable cloth and preferably of an absorbent terry cloth fabric. For the preferred embodiment with the frame 11 constructed with bracket connectors 14 having openings 17 which form a loop at each end thereof the strip 13 of connecting material may be removably attached at each end 15 and 16 using a connecting means such as a snap fitting 18 and/or a Velcro liner 23. In the preferred embodiment as shown in FIG. 3 a snap fitting 18 is mounted into the strip 13 at one of the ends 15 or 16 thereof. For purposes of illustration the snap fitting 18 is shown forming a fastener mounted on the right side of the frame 11 adjacent the end 16. The snap fitting 18 includes a male member 19 affixed to the strip 13 at one end 20 and a female member 21 attached to the strip 13 at a location 22 spaced a predetermined distance apart from the end 20. A lining 23 of Velcro is connected to a surface of the strip 13 and extends along a section 24 thereof at the end opposite to the end of the strip 13 in which the snap fitting 18 is mounted to form another fastener as shown on the left side of the frame 11. The Velcro lining 23 may simply be sewed to the strip 13 and should be of a length so that the Velcro lining 23 functions as a fastener by overlapping the lining and pressing the overlapped sections. The strip 13 of connecting material is threaded through the bracket connectors 14 at the opposite ends 15 and 16 of the frame 11 with the male member 19 snapped into the female member 21 to form a closure at the right end of the frame 11 and with the Velcro lining 23 attached to itself to form an adjustable closure at the left end of the frame 11. The eyeglasses may be loosened or tightened by opening the connected position of the Velcro lining 23 along the section 24 as shown in FIG. 3 and reattaching itself at a different position.

What we claim is:

1- An eyeglass assembly for use following surgery comprising a temple less frame for housing a pair of lenses, a bracket connector extending from each opposite end of the frame on the left and right side thereof and a strip of a connecting material composed of a soft looped absorbent cloth with said strip of connecting material having a fastener at each opposite end thereof for removably attaching the strip of connecting material to each bracket connector.

2- An eyeglass assembly as defined in claim 1 wherein each bracket connector has an opening for forming a loop through which the strip of connecting material extends for connecting said strip to the frame by means of said fasteners.

3- An eyeglass assembly as defined in claim 2 wherein said strip of connecting material is composed of terry cloth.

4- An eyeglass assembly as defined in claim 3 wherein at least one of said fasteners is a snap fitting.

5- An eyeglass assembly as defined in claim 4 wherein said snap fitting includes a male and female member both affixed to the strip of connecting material at one end thereof spaced a predetermined distance apart.

6- An eyeglass assembly as defined in claim 3 wherein at least one of said fasteners comprises a Velcro lining affixed along an end of the strip of connecting material.

7- An eyeglass assembly as defined in claim 4 wherein said snap fitting is affixed to the strip of connecting material at one end thereof and wherein said other fastener is a Velcro lining affixed on the surface of the strip of connecting material at the opposite end thereof.
